(19) United States
(12) Patent Application Publication
(10) Pub. No.: US 2006/0195839 A1
(43) Pub. Date: Aug. 31, 2006

(54) Computer system for deploying software on multiple computers

(75) Inventors: YiCheng Michael Lin, Redmond, WA (US); Troy W. Hughes, Maple Valley, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/068,552

(22) Filed: Feb. 28, 2005

(51) Int. Cl. G06F 9/445

(52) U.S. Cl. 717/174

(57) ABSTRACT

A method for deploying operation systems on multiple test computers is provided. A user interface also provides unified management of the multiple computers. A custom bootable removable media, such as a compact disc, is loaded on or is otherwise associated with each of the multiple computers. The computers are connected, for example, by a network, to a database and a test lab manager. The custom bootable removable media includes a build script. A user computer provides settings to the build script, for example by a template and via the server. The build script utilizes the settings to configure a disc for each of the client computers, and then installs an operating system on the disc in accordance with the settings.

### FIELD OF THE INVENTION

This invention relates generally to software, and more particularly to deploying software for testing in a lab environment.

### BACKGROUND OF THE INVENTION

Contemporary tests on software are sometimes performed in large labs that have multiple computers. In accordance with one prior art method disclosed in U.S. Published Application Number 2003/0131285, application or software testing is performed on multiple computers having different platforms (e.g., operating systems and upgrade levels), and/or languages. To conduct tests on the multiple computers, a test system communicates with the computers, via a thin client, to request application operations.

While the system above works well for testing application software, a problem exists for testing computers not already including an operating system or for testing deployment of an operating system. In such a configuration, the test system does not have a component (i.e., the operating system) with which to communicate.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a method for deploying operation systems on multiple test computers is provided. A system also provides unified management of the multiple computers.

In accordance with an embodiment, a custom bootable removable media, such as a compact disc, is loaded on or is otherwise associated with each of the multiple computers. The computers are connected, for example, by a network, to a database and a test lab manager. The custom bootable removable media includes a build script. A user computer provides settings to the build script, for example by a template and via the server. The build script utilizes the settings to configure a disc for each of the client computers, and then installs an operating system on the disc in accordance with the settings.

In accordance with an embodiment, after the operating system is installed, the custom bootable removable media installs a client service on the disc. The client computer also logs on as an autologon user in accordance with a user definition supplied in the template or other information provided by the user machine, and runs any options selected by the user machine and provided in the template, such as the installation of a firewall or disabling or enabling of features in the computer.

In accordance with an embodiment, the status of the computer is reported to the database on a regular basis, at first by the custom bootable removable media, and then by the client service loaded on the computer. Remote commands may be sent to the client machine from the user machine and may be run in the user context that was defined by the user machine. Special remote commands allow the user machine to clean install or upgrade the installed operating system from a user interface provided on the user machine. The user interface also provides a view of the heartbeat and status of the computers in that are connected to the test lab management system.

Once a computer is registered and configured in the test lab management system, a user, via the user interface, can install an operating system on the computer, and can perform actions with the computer after the operating system is installed, such as installing and testing software applications on the computer. The user can also start over by clean installing the same or another operating system on the computer. The process is fully automated, and can be tracked through the user interface at any time.

Other features of the invention will become apparent from the following detailed description when taken in conjunction with the drawings, in which:

### BRIEF DESCRIPTION OF THE DRAWINGS

FIG. 1 illustrates an example of a suitable computing system environment on which the invention may be implemented;

FIG. 2 shows a block diagram of an architecture of a test lab management system in accordance with an embodiment of the present invention;

FIG. 3 shows a block diagram representing components of a custom bootable removable media in accordance with an embodiment of the present invention;

FIG. 4 shows a general overview of a process for deploying an operating system on a test lab client computers in accordance with an embodiment of the invention;

FIG. 5 shows a general overview of a process for performing steps 408 and 410 of FIG. 4 in accordance with an embodiment of the invention;

FIG. 6 is a block diagram generally representing communication in a test lab management system prior to installation of an operating system on test lab client computers in accordance with an embodiment of the invention;

FIG. 7 is a block diagram generally representing communication in a test lab management system after installation of an operating system on test lab client computers in accordance with an embodiment of the invention;

FIG. 8 shows a general overview of a process for monitoring the heartbeat of a test lab client computer in accordance with an embodiment of the invention; and

FIG. 9 shows an example of a user interface that may provide functions of the test system in accordance with an embodiment of the invention.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

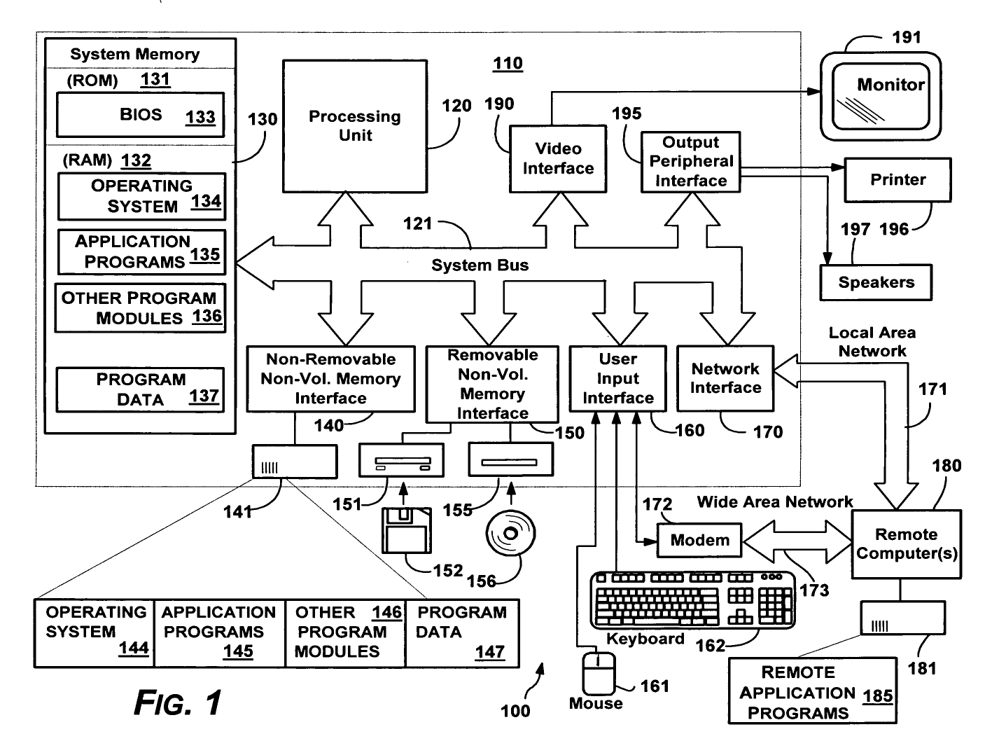

Referring now to the drawings, in which like reference numerals represent like parts throughout the several views, FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

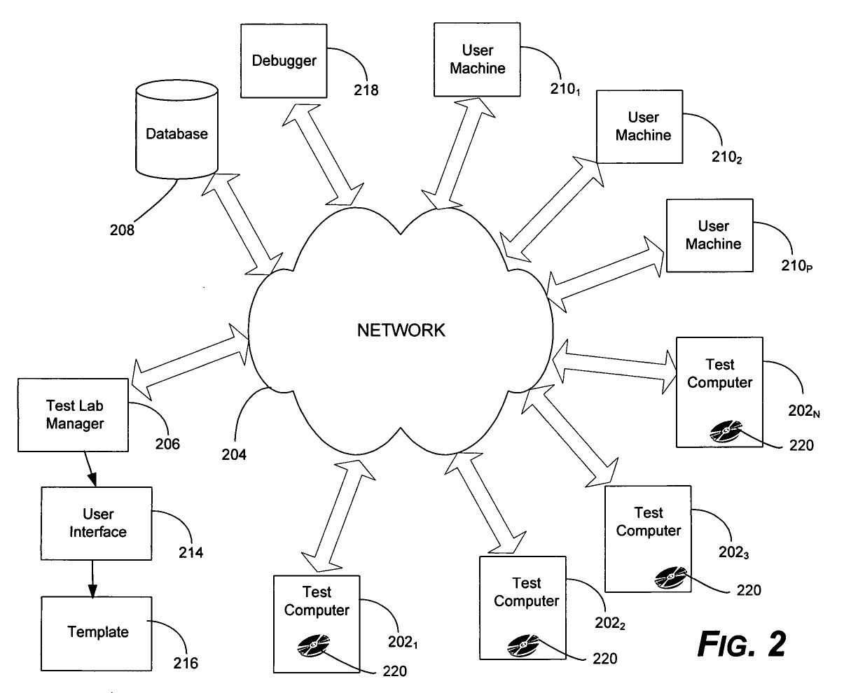

FIG. 2 shows a block diagram of an architecture of a test lab management system 200 in accordance with an embodiment of the present invention. The test lab management system 200 includes a number of test lab client computers 202₁, 202₂, 202₃ . . . 202N. The test lab client computers 202 are connected via a network 204 to a test lab manager 206, which may be, for example, a server computer for the client computers 202. The test lab manager 206 includes or is otherwise affiliated with a database 208.

One or more user machines 210₁, 210₂ . . . 202ₚ are connected to the test lab manager 206 by a network, which is shown as the network 204 in the drawings, but can be a different network than the network 204. Each of the user machines 210 has access to a user interface 214 that is hosted by the test lab manager 206. As is described below, the user interface 214 may be utilized by the user machines 210 to provide information to the test lab manager 206 regarding desired configurations and settings for installation of operating systems on the test lab client computers 202. These settings may be supplied by a template 216.

A debugger computer 218 is also associated with the network 204. The function of the debugger computer 218 is described below.

In an embodiment, the test lab client computers 202 are organized into labs. Each lab may include one to many test lab client computers 202. In addition, multiple test lab managers 206 may be provided, but for ease of description, only one is shown in the drawings.

The client computers 202, the test lab manager 206, and the user machines 210 may be configured much as the computer 110. In addition, although the user machines 210 are shown remote from the test lab manager 206, the function and elements of the user machine may be included on the same computer as the test lab manager 206. However, one advantage provided by the present invention is that the user machines may be remotely located from the test lab manager 206. The network 204 may be a LAN, such as the LAN 171, a WAN, such as the WAN 173, the Internet, or any suitable network.

In accordance with an embodiment, a separate custom bootable removable media 220 is installed on or is otherwise associated with each of the test lab client computers 202. The custom bootable removable media 220 is installed on the test lab client computers 202, meaning at least a portion of the custom bootable removable media 220 is installed in memory (e.g., the RAM 132. The custom bootable removable media 220 may be, for example, a magnetic disk, such as the magnetic disk 152, an optical disk, such as the optical disk 156, a magnetic tape cassette, a flash memory card, a digital versatile disc, a digital video tape, or other suitable custom bootable removable media. In accordance with an embodiment, the custom bootable removable media is a CD-ROM.

Briefly described, a user machine 210 desiring to run tests on a number of test lab client computers 202 may deploy a desired operating system and platform at each of the test lab client computers 202 utilizing the user interface 216 and the custom bootable removable media 220. Information about each of the test lab client computers 202 is maintained at the database 208. The process is fully automatic, and does not require operator input at the test lab client computers 202.

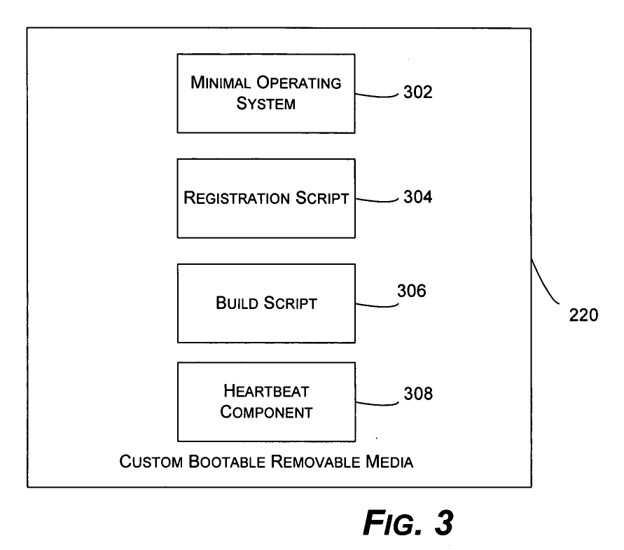

FIG. 3 shows a block diagram representing components of the custom bootable removable media 220. The removable media 220 includes a minimal operating system 302, a registration script 304, a build script 306, and a heartbeat component 308. The minimal operating system includes sufficient files to allow booting of one of the client computers 202 off of the removable media 220, as well as sufficient components to start the installation of an operating system. One example of a minimal operating system is the WINDOWS Pre-installation Environment (WinPE) minimal operating system based upon Microsoft Corporation's WINDOWS XP operating system kernel. WinPE provides a graphical user interface environment during installation instead of typical text-based screen prompts that are common during the initial setup of earlier operating systems. The functions of the registration script 304, the build script 306, and the heartbeat component 308 are described below.

FIG. 4 shows a general overview of a process for deploying an operating system (e.g., the operating system 134) on one of the test lab client computers 202 in accordance with an embodiment of the invention. Beginning at step 400, the custom bootable removable media 220 registers the test lab client computer 202 with the test lab manager 206. In an embodiment, the custom bootable removable media 220 utilizes the registration script 304 with this process. In one manner of doing this, upon the first boot of the test lab client computer 202, the registration script 304 on the custom bootable removable media 220 connects to the test lab manager 206 and registers the client computer 202, and such information is stored on the database 208.

In the description herein, some operations are described as being performed by the registration script 304, while others are described as being performed by other components of the custom bootable removable media 220. However, the components described herein are for convenience, and one or more of the components may be combined to form a single component, functions may be distributed in a different manner over the components, one or more of the components may be divided into multiple components, and/or different components may be provided altogether. Thus, the description herein is but one arrangement available for the custom bootable removable media 220.

At step 402, a user machine 210 supplies configuration information to the test lab manager 206. The configuration information may be entered manually via the user interface 214. As an alternative to providing manual configuration information via the user interface 214, a user at one of the user machines 210 may select and apply one of the templates 216, which includes a set of settings.

The configuration information includes a number of settings defining hardware configuration, operating system, and other options that are desired by the user machine 210. In accordance with an embodiment, these configuration settings are deployed at each of the client computers 202 that will be utilized for tests for the particular user machine 210.

At step 404, the registration script 304 of the custom bootable removable media 404 detects the settings supplied in the configuration information. These settings may have been automatically sent by the test lab manager 206 upon receipt from the user machine 210, or may be routinely requested by the client computer 202.

At step 406, the build script 306 of the custom bootable removable media 220 configures the hardware on the client computer 202 in accordance with the settings in the configuration information. This may involve partitioning of a drive or drives and the formatting of a disk or disks. As examples, a single partition may be created on the primary hard disk and formatted, an existing partition may be used with no disk configuration other than formatting the install partition, or some form of custom configuration may be provided. A disk partition may be performed and formatting may be provided for the separate partitions in accordance with the settings in the configuration information.

After the hardware is configured in step 406, the build script 306 of the custom bootable removable media 220 installs an operating system on the client computer 202 at step 408. At step 410, the removable media 220 installs a client test service on the client computer 202. A client test service is a service that permits a computer, such as the test lab manager 206 or the user machine 210 to interact with the installed operating system to perform tests on that operating system.

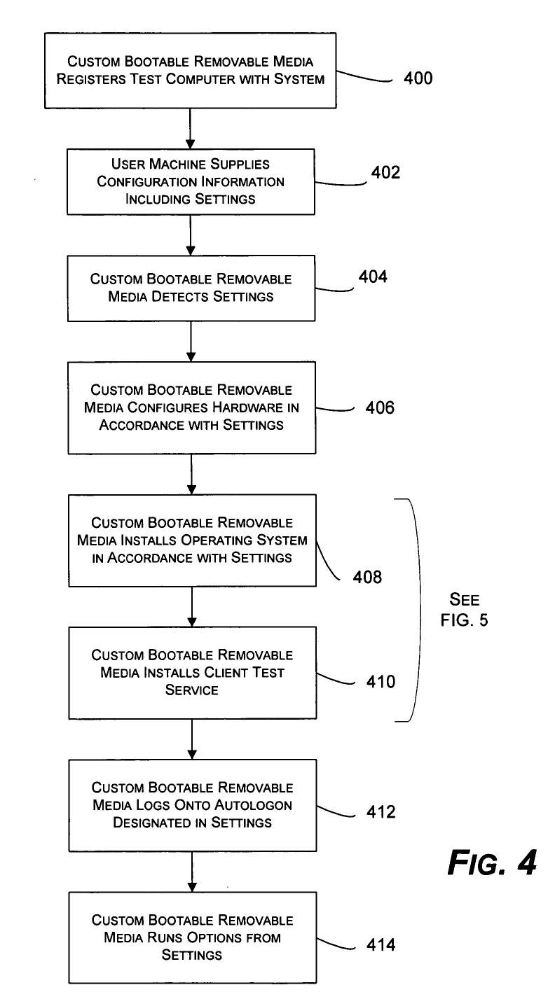

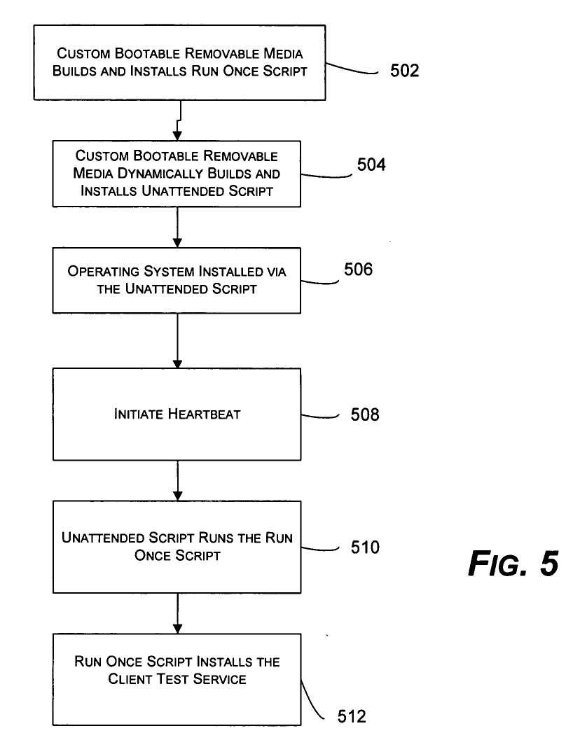

FIG. 5 shows a general overview of a process for performing steps 408 and 410 in accordance with an embodiment of the invention. Beginning at step 502, the removable media builds and installs a run once script. As is known, a run once script permits a program to start after boot up of (or in this case, after installation of) an operating system. The run once script is installed on the client computer 202. At step 504, the build script 306 of the custom bootable removable media 220 dynamically builds an unattended script and populates it with values previously provided to the database 208 as part of the configuration information (step 402). The unattended script permits the operating system to be installed without input from a user at the client computer 202 (i.e., settings are automatically entered, the test lab client computer 202 is rebooted as needed without prompt, and so forth). In accordance with an embodiment, the unattended script is set to run the run once script the first time a user logs on to the computer after the final stage of the setup of the operating system. At step 506, the operating system is installed. This may involve copying setup files (e.g., from the database 208 or the test lab manager 206) to the hard drive, marking the active partition, and then rebooting to start the process. By marking the active partition, the test lab client computer 202 then boots from the hard drive first, instead of the CD (or custom bootable removable media 220). After the complete operating system is installed, at step 508 the client test services will initiate a heartbeat to monitor the health of the computer 202. At step 510, the run once script is run. At step 512, the run once script installs the client test service on the client computer 202.

Returning now to FIG. 4, at step 412, the custom bootable removable media 220 logs into the auto logon user designated in the settings of the configuration information. The custom bootable removable media 220 then at step 414 runs options defined in the settings, which may include installation of software, such as anti-virus software, disabling of some features, such as screen savers, or additional configuration of the operating system to get the test lab client computer 202 ready for use.

The client computers 202 are then ready to perform tests requested by the particular user machine 210. The user machine 210 is ensured of the operating system and platform configuration on which it desired the performance of the tests. The user machine 210 may now communicate with the client test service to request particular test or tests on the client computers 202.

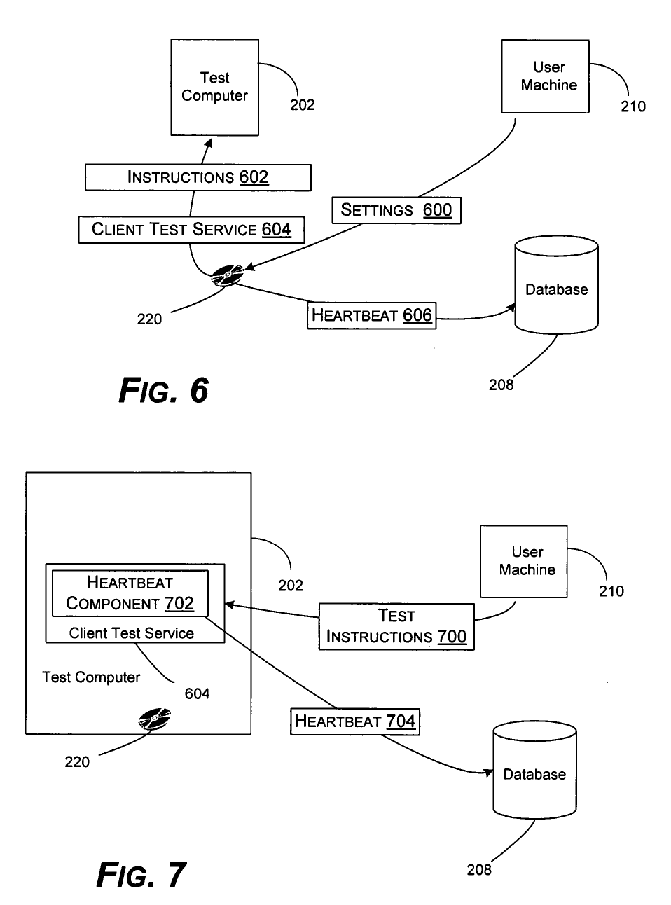

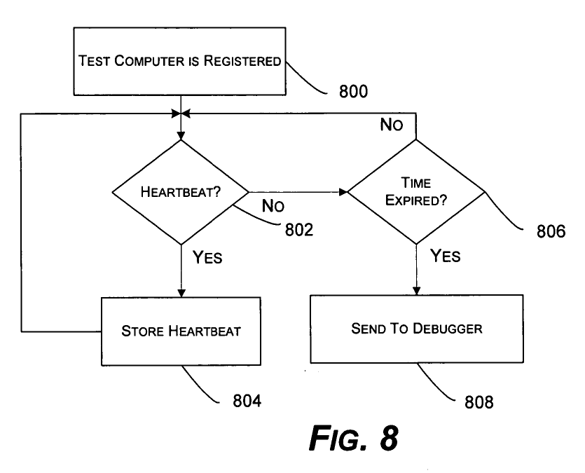

FIG. 6 is a block diagram generally representing communication in the test lab management system 200 prior to installation of an operating system on the test lab client computers 202. FIG. 7 is a similar figure showing communication after installation of the operating system.

As can be seen in FIG. 6, the user machine 210 provides settings 600, for example via the user interface 214. The custom bootable removable media 220 provides installation instructions 602 to the test lab client computer 202 and installs the client test service 604 on the test lab client computer 202. Although the figure shows communication directly with the custom bootable removable media 220, as is known, the actual communication is with portions of the custom bootable removable media 220 loaded in the memory of the computer, e.g., the RAM 132.

After the operating system is installed, as is shown in FIG. 7, the user machine 210 may communicate directly with the client test service 604 that is installed on the test lab client computer 202. This communication may also be via the user interface 214. As an example, test instructions 700 may be provided to the client test service 604. The test instructions 700 may include one or more scripts that, for example, instruct the test lab client computer 202 to download and install a software application, run an application, and/or perform an operation within an application.

In accordance with an embodiment, the removable media 220 reports to the test lab manager 206 on a regular basis, for example every five minutes, to update machine configuration, computer name, and heartbeat. This information is stored on the database 208. In this manner, the user machines 210 may monitor the progress of installation of the operating system or other functions occurring at the client computers 202. This monitoring may be performed, for example, by accessing the database 208 via the user interface 214.

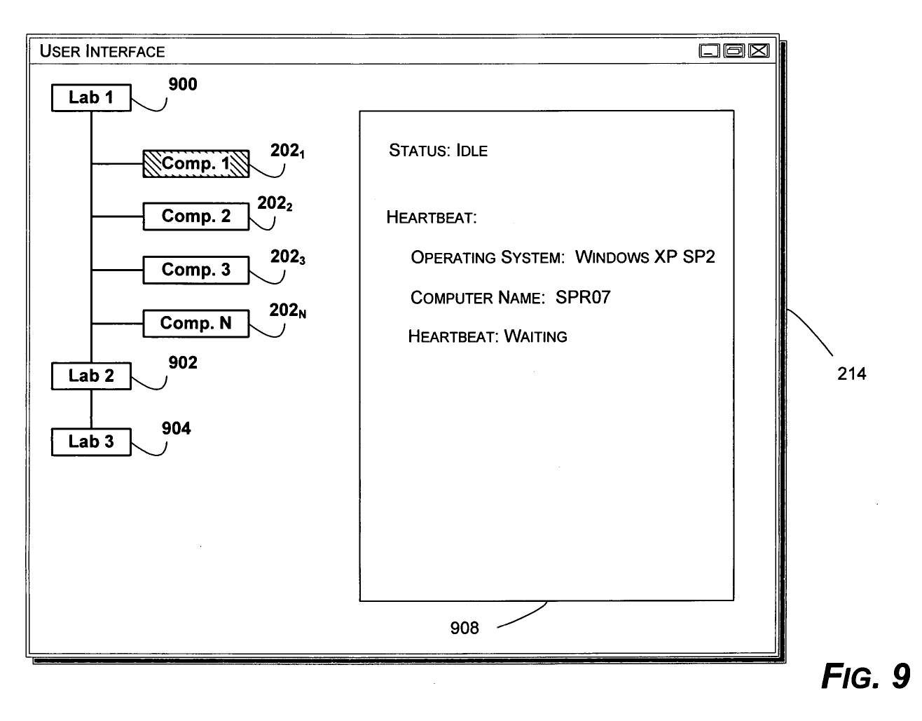

FIG. 8 shows a general overview of a process for monitoring the heartbeat of a test lab client computer 202 in accordance with an embodiment of the invention. Beginning at step 800, the test lab client computer 202 is registered, as is described above. At step 802, a determination is made whether a heartbeat has been received from the test lab client computer 202. If so, the process branches to step 804, where the heartbeat information is stored, for example in the database 208. The process then branches back to step 802, awaiting the next heartbeat.

If a heartbeat is not received at step 802, then the process branches to step 806, where a determination is made whether the time limit in which a heartbeat is supposed to be received has expired. This time may be, for example, two hours. The time takes into account the fact that the test lab client computer 202 may be undergoing a process that slows down or temporarily delays the delivery of heartbeats. For example, during the process of installing an operating system, which takes longer than the normal time between heartbeats, a heartbeat is not sent. However, in accordance with an embodiment, the time set for step 806 is sufficient for installation of an operating system.

In addition, there are times when the heartbeat will lag because the test lab client computer 202 is busy. If the time has not expired, step 806 branches back to step 802, where the process continues. If the time has expired, than step 806 branches to step 808, where control of the test lab client computer 202 is given to the debugger computer 218. The debugger may then attempt to repair the test lab client computer 202 in a manner known in the art.

After installation, at the time period depicted in FIG. 6, the heartbeat component 308 of the custom bootable removable media 220 sends heartbeats 606 (FIG. 6) to the database 208. After the operating system is installed, heartbeats 704 are provided via the client test service 604, for example via a heartbeat component 702.

The custom bootable removable media 220 may also handle remote commands, which may be sent to the client computer 202 from the user machines 210, for example via the user interface 216. These remote commands may be run in the logged-on user context provided at step 412. Special remote commands may allow the user machine 210 to clean install or upgrade the installed operating system from the user interface 214.

Access to the client computers 202 by the user machines 210 may be controlled at the test lab management system 200. The user interface 214 may provide viewing of all client computers 202 on the system, but may provide control over client computers 202 to only those client computers for which the user machine 210 has access. A user having access to a particular test lab management system 200 may be able to add or remove client computers 202 from that management system, view or change settings of client computers 202 on the system, or run remote commands. The user machine 210 can apply templates, bulk updates settings, or can run remote commands on any number of client computers 202 in the test lab management system 200. Each client computer 202 has a status and heartbeat associated with it and maintained by the database 208. The status is changed through the use of the client test service residing on the client machine, and can be called by the user machine 210 having access at any time to set the current status of the client computer 202.

The present invention provides a fully automated and fully configurable operating system deployment solution. In addition, the invention provides unified management of computer lab resources. Once a client computer 202 is registered and configured to operate with the test lab manger 206, it can install an operating system, perform any actions specified by one of the user machines 210, and then can start over by clean installing the same operating system or a different operating system. The system can be tracked at the database 208 and monitored via the user interface 214 along the way.

FIG. 9 shows an example of a user interface that may provide functions of the user interface 214 in accordance with an embodiment of the invention. On the left side of the user interface 214, a tree structure is provided showing labs 900, 902, 904, each having computers therein (only Lab 1 is expanded to show computers). In the example shown, Lab 1, designated by the reference numeral 900, includes the computers 202₁, 202₂, 202₃ . . . 202_{N} shown in FIG. 2. In the example shown, the test lab client computer 202₁ is highlighted. In a window pane 908, the status and heartbeat of the test lab client computer 202₁ is shown. Other screens or window panes may be arranged in the user interface 214 for providing script, settings (e.g., via the template 216), or remote commands for the computers. One or more computers may be selected. As long as a user at the user machine 210 has access, the user can apply a template or settings to one or more of the test lab client computers 202.

In the example shown in FIG. 9, the computer has a status of “idle.” The status of the computer may be a number of other things, such as “installing,” when the test lab client computer 202 is installing an operating system, “testing,” when test scripts are being run via the client test service 604, or “not responding/offline,” when the test lab client computer is not responding (e.g., not sending any heartbeats). The heartbeat in the example shown provides the computer configuration (in the example, WINDOWS XP operation system, Service Pack 2), computer name (SPR07), and the heartbeat (in the example, “waiting”).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer system comprising:
a computer; and
a removable computer media installed on the computer and having computer-executable components thereon, comprising:
an operating system component comprising a bootable portion configured to boot the computer; and
an installation component configured to, responsive to receiving an installation request from a remote computer, install an operating system on the computer.

2. The computer system of claim 1, wherein the removable computer medium comprises a CD-ROM.

3. The computer system of claim 1, wherein the removable computer medium comprises a member of the set of a flash memory card, a digital versatile disc, and a digital video tape.

4. The computer system of claim 1, wherein the installation component further comprises a configuration component for configuring hardware on the computer prior to installing the operating system.

5. The computer system of claim 4, wherein the configuration component is configured to format a hard drive on the computer.

6. The computer system of claim 4, wherein the configuration component is configured to partition a hard disk on the computer.

7. The computer system of claim 1, wherein the removable computer media includes further computer-executable components comprising a registration component that is configured to register the computer with a test management system, and wherein the installation request is received from a user of the test management system.

8. A computer system, comprising:
a test management component; and
a plurality of test computers, each computer having installed thereon a removable computer media having computer-executable components thereon, the components comprising:
an operating system component comprising a bootable portion configured to boot the computer; and
an installation component configured to, responsive to receiving an installation request from the test management component, install an operating system on the computer.

9. The computer system of claim 8, wherein the removable computer medium comprises a CD-ROM.

10. The computer system of claim 8, wherein the installation component further comprises a configuration component for configuring hardware on the computer prior to installing the operating system.

11. The computer system of claim 8, wherein the configuration component is configured to format a hard drive on the computer, partition a hard disk on the computer, and subsets thereof.

12. The computer system of claim 8, wherein the removable computer media includes further computer-executable components comprising a registration component that is configured to register the computer with the test management system.

13. The computer system of claim 8, further comprising a user interface through which a user may provide configuration settings to the installation component for each of the computers.

14. The computer system of claim 8, further comprising a user interface through which a user may provide a request to the installation component, after the operating system has been installed, to clean install an operating system on one or more of the plurality of computers.

15. A method of remotely installing an operating system on a plurality of computers, comprising:
installing a removable computer media having computer-executable components thereon, the components comprising:
an operating system component comprising a bootable portion configured to boot the computer; and
an installation component configured to, responsive to receiving an installation request from the test management component, install an operating system on the computer;
requesting, via a remote call, a batch install of the operating system on each of the plurality of computers; and
responsive to the remote call, the installation component installing the operating system on each of the plurality of computers.

16. The method of claim 15, further comprising, prior to installing the operating system, requesting via a second remote call, configuration of each of the plurality of computers, and responsive to the second remote call, configuring hardware on each of the computers.

17. The method of claim 16, wherein the remote call and the second remote call are made together via a user interface.

18. The method of claim 16, wherein configuring hardware comprises partitioning a hard disk, formatting a partition, and subsets thereof.

19. The method of claim 15, further comprising, prior to requesting the remote call, registering each of the plurality of computers with a management system.

20. The method of claim 19, wherein registering occurs as a consequence of installing the removable computer media.
